(19) United States
(12) Patent Application Publication
(10) Pub. No.: US 2004/0018046 A1
(43) Pub. Date: Jan. 29, 2004

(54) Connecting element

(76) Inventor: Aaron Daly, Waldachtal (DE)

Correspondence Address: STRIKER, STRIKER & STENBY, 103 East Neck Road, Huntington, NY, 11743, US

(21) Appl. No.: 10/446,217

(22) Filed: May 28, 2003

(30) Foreign Application Priority Data
Jul. 26, 2002 (DE) 202 11 288.8

(51) Int. Cl. F16B 12/36

(52) U.S. Cl. 403/295

(57) ABSTRACT

A connection element (1) for mechanical connection of components (2, 3) or the like consists of two coupling halves (4, 5) capable of being brought into engagement, which are each arranged to be fixed by means of screws (6) or the like to a respective one of the components (2, 3) to be connected. The coupling halves (4, 5) have screw seats (7) for the screws (6). In order to produce a fixing of the coupling halves (4, 5) for connection elements that permits approximate and precision positioning, and at the same time ensure a stable bearing surface for the screw, the screw seats (7) each have a screw head bearing surface (8), the form of which corresponds over its entire circumference with the geometry of the screw head (10). A supporting sleeve (9) adjoins the screw head bearing surface (8) in the component direction, the internal cross-section of the supporting sleeve (9) widening in the component direction. The supporting sleeve (9) rests at its end face (11) on the component (2, 3) to be connected.

### BACKGROUND OF THE INVENTION

The present invention relates to a connection element for mechanical connection of components or the like.

Such connection elements are known, for example, from DE 10026769 A1. Here, within the context of a pre-assembly, a coupling half is fixed by means of a screw to each one of two components or the like to be connected. To connect the components, the coupling halves are brought into engagement. During pre-assembly, the connection element is held first against the respective component and at the same time positioned approximately. The screws are then pushed through the corresponding screw seats and largely screwed into the components. Either self-tapping screws or metric threads in conjunction with a prepared threaded bore are used. In the next step, the coupling halves are positioned exactly and the screw is driven home. To ensure that it is possible to make adjustment from the approximate position to effect precision positioning, the known coupling halves have slots, the edge of which is supported relative to the component by means of supporting sleeves of appropriate length.

The trouble with the known connection elements is that when the screws are screwed in using a power screwdriver, the screws often break through the screw seat owing to the inadequate bearing surface for the screw head, thus rendering a reliable fixing process impossible. In addition, displacement to effect precision positioning is possible in one direction only, that is, in the lengthwise direction of the slot.

### SUMMARY OF THE INVENTION

The invention is based on the problem of producing a fixing of the described coupling elements for connected elements, which permit an approximate and precision positioning and at the same time ensure a stable bearing surface for the screw.

That problem is solved according to the present invention by the connection element having the features of claim 1. The coupling halves of the connection element have screw seats, the screw head bearing surface of which supports the screw around its entire circumference. The screw head bearing surface is thus matched to the geometry of the screw head, for example, it is conical for countersunk head screws. It is therefore not a slot but a rotationally symmetrical hole combined with a rotationally symmetrical bearing surface for the screw head. The forces acting on the screw head bearing surface are diverted into the component by a supporting sleeve, which rests on the component. By the arrangement of the supporting sleeve directly adjacent to the screw head bearing surface, shearing forces and bending moments in the region around the screw head bearing surface are largely avoided, and consequently, a very high loading of the screw is possible. To be able to ensure an approximate and a precision positioning, the internal cross-section of the supporting sleeve widens in the component direction, preferably conically, so that it is possible to displace the coupling halves in any direction when screws have already been partly screwed in.

Apart from the supporting sleeves, the coupling halves engage the corresponding component at further areas, for example, at the edge and/or reinforcing ribs. By diverting the screw forces via the supporting sleeve, the largest surface area forces occur at the ends of the supporting sleeves. In the case of soft material, for example, wood, this can lead to the component being pressed in the region of the supporting sleeves. The effect of this can be bending inside the coupling halves with the consequence of cracks. To prevent this, a preferred embodiment of the invention provides for the front face of the supporting sleeve to extend beyond the engagement plane of the coupling half. The supporting sleeve thus comes into contact with the component before the other bearing surfaces of the coupling half penetrates subsequently into the material, and compresses and compacts it. Only when high tightening forces have already been reached do the other regions of the coupling half come into engagement. Thus, on the one hand, bowing is avoided, and on the other hand, the penetration into the component produces an interlocking connection, which is able to accommodate significantly higher forces than a purely frictional engagement of the coupling halves.

This effect can be reinforced by arranging projections on the end face of the supporting sleeve. Such projections, for example, a toothed rim or an annular cutting edge, are especially suited for penetrating the component, even in the case of relatively hard material. If the material is a hard material, however, such as steel, for example, the end face of the supporting sleeve terminates flush with the bearing surface of the coupling half.

To optimize the lines of force within the coupling halves, a preferred embodiment of the invention provides for the supporting sleeve to have reinforcing ribs, which connect the supporting sleeve, for example, radially, with the edge of the coupling half or with a further supporting sleeve.

### BRIEF DESCRIPTION OF THE DRAWING

FIG. 1 shows the connection device of the present invention with two coupling halves for connecting two components.

### DETAILED DESCRIPTION OF THE PREFERRED EMBODIMENTS

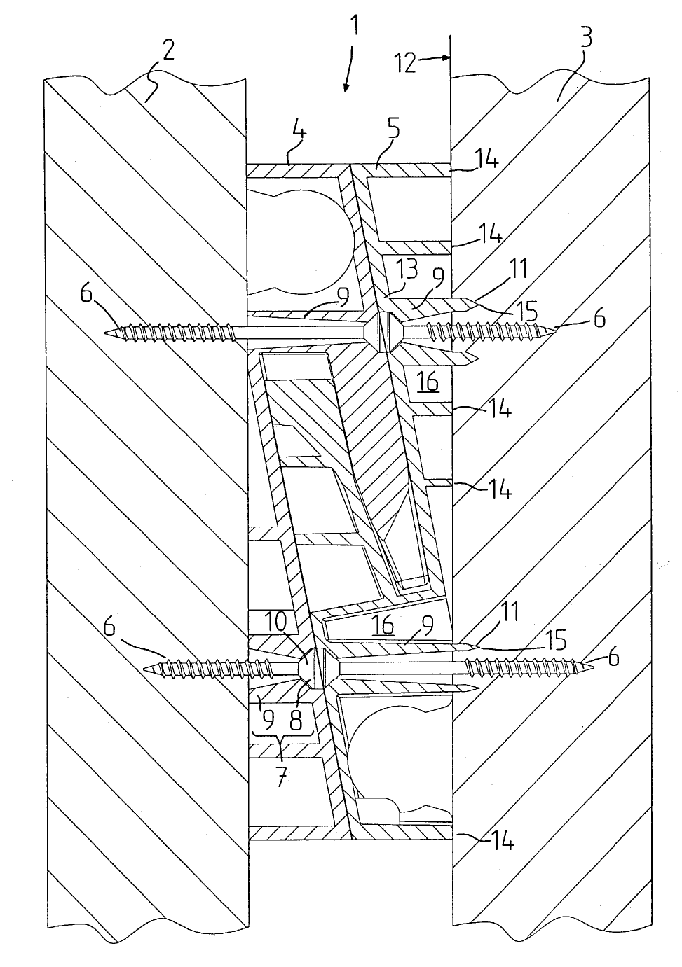

The connection element 1 illustrated in FIG. 1 for connecting the two components 2 and 3 consists of the two coupling halves 4 and 5. In the assembled state illustrated, these engage in one another and are each secured to the components 2 and 3 by countersunk head screws 6. For that purpose, the coupling halves 4 and 5 each have several screw seats 7. The screw seats 7 comprise, on the one hand, a screw head bearing surface 8 and on the other hand, a supporting sleeve 9 resting on the respective component 2, 3. The screw head bearing surface 8 is of conical form resulting in a surface abutment of the screw head 10 of the countersunk head screw 6. The internal cross-section of the supporting sleeve 9 widens conically towards the component.

During pre-assembly of the coupling halves 4 and 5 on the components 2 and 3, the coupling halves 4 and 5 are first positioned approximately and the countersunk head screws 6 are screwed in, for example, using a power screwdriver, to half their ultimate insertion depth. This enables the countersunk head screws 6 already to bear the weight of the coupling halves 4 and 5. Following that, the coupling halves 4 and 5 are precisely positioned. Owing to the resilience of the countersunk head screws 6 and/or of the material of the components 2 and 3 and especially owing to the conical internal cross-section of the supporting sleeve 9, a perceptible displacement can be effected. In contrast to a longitudinally slit screw seat, such displacements can be effected in any direction. Once the exact position has been reached, the countersunk head screws 6 are tightened further until their screw head 10 rests on the screw head bearing surface 8. As a result of the surface abutment, it is impossible for the screw head bearing surface 8 to be broken through. Tests have shown that correspondingly high tightening torques previously lead to failure of the countersunk head screw 6 or of the component 2. In the finished assembled state, the screw head 10 acts on the screw head bearing surface 8, which transfers the corresponding forces substantially via the supporting sleeve 9 directly to the components 2 and 3.

In the exemplary embodiment illustrated, the component 2 is a hard material, for example, steel, while the component 3 consists of a softer material, for example, wood. In the case of the coupling half 3, therefore, the end faces 11 of the supporting sleeves 9 extend beyond the plane of engagement 12 of the coupling half 3. It this were not the case, the supporting sleeves 9 themselves would penetrate into the material on account of the force distribution and in so doing, would deform at their edges 13, compared with the rest of the coupling half 5. This would lead to stress increases in the material, with the risk of crack formation. As a consequence of the chosen geometry, however, before the remaining bearing surfaces 14 engage, the material of the component 3 is compressed and thereby compacted in the region of the end faces 11 of the supporting sleeves 9. Extending the supporting sleeves 9 relative to the plane of engagement 12 is chosen so that at a customary tightening torque of the countersunk head screws 6, on the one hand, the supporting sleeves 9 and the remaining bearing surfaces 14 engage, and on the other hand, a distortion of the supporting sleeves 9 at their edges 13 is largely avoided. Penetration of the supporting sleeves 9 into the material of the component 3 has the advantage that, in addition to a frictional engagement, an interlocking engagement is established between coupling half 5 and the component 3. This substantially increases the transferable forces. Projections 15 are therefore additionally provided on the front side 11 of the supporting sleeve 9. While a circumferential edge is provided as a projection 15 in the exemplary embodiment illustrated, this projection could also be in the form of a toothed rim of the like.

In order to promote the distribution of forces, the exemplary embodiment additionally has reinforcing ribs 16, which connect the supporting sleeves 9 with further bearing surfaces 14.

In the case of component 2, which consists of a hard material, the effect of the deformation of the supporting sleeves 9 does not occur, since the component 2 exhibits virtually no yield. Projecting supporting sleeves 9 are therefore not provided here.

It will be understood that each of the elements described above, or two or more together, may also find a useful application in other types of constructions differing from the types described above.

While the invention has been illustrated and described herein as a connection element, it is not intended to be limited to the details shown, since various modifications and structural changes may be made without departing in any way from the spirit of the present invention.

Without further analysis. the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A connection element (1) for mechanical connection of components (2, 3), comprising two coupling halves (4, 5) that can be brought into engagement, wherein the two coupling halves (4, 5) are each arranged to be fixed by means of screws (6) or the like to a respective one of the components (2, 3) to be connected, and wherein the coupling halves (4, 5) have screw seats (7) for the screws (6), wherein the screw seats (7) each have a screw head bearing surface (8) having a form that corresponds over an entire circumference of the screw head bearing surface (8) with a geometry of a screw head (10), and wherein a supporting sleeve (9) adjoins the screw head bearing surface (8) in a direction of the components, wherein the internal cross-section of the supporting sleeve (9) widens in the direction of the components, and wherein the supporting sleeve (9) rests at its end face (11) on the component (2, 3) to be connected.

2. The connection element according to claim 1, wherein the form of the screw head bearing surface (8) corresponds to a geometry of a countersunk head screw (6).

3. The connection element according to claim 1, wherein an internal cross-section of the supporting sleeve (9) is of conical form.

4. The connection element according to claim 1, wherein the end face (11) of the supporting sleeve (9) extends beyond an engagement plane (12) of one of the coupling halves (5).

5. The connection element according to claim 1, wherein the end face (11 ) of the supporting sleeve (9) has projections (15).

6. The connection element according to claim 1, wherein the supporting sleeve (9) has reinforcing ribs (16).
